(19) United States
(12) Patent Application Publication
(10) Pub. No.: US 2020/0132160 A1
(43) Pub. Date: Apr. 30, 2020

(54) DRIVING BELT

(71) Applicants: TOYOTA JIDOSHA KABUSHIKI KAISHA, Toyota-shi (JP); AISIN AW CO., LTD., Anjo-shi (JP)

(72) Inventors: Yu INASE, Susono-shi (JP); Keisuke NINOMIYA, Susono-shi (JP); Yuji HATTORI, Ichinomiya-shi (JP); Yuji NAGASAWA, Nagakute-shi (JP); Akira OCHI, Anjo-shi (JP); Wataru ISHIHARA, Anjo-shi (JP); Junichi TOKUNAGA, Anjo-shi (JP)

(73) Assignees: TOYOTA JIDOSHA KABUSHIKI KAISHA, Toyota-shi (JP); AISIN AW CO., LTD., Anjo-shi (JP)

(21) Appl. No.: 16/656,666

(22) Filed: Oct. 18, 2019

(30) Foreign Application Priority Data
Oct. 29, 2018 (JP) 2018-202674

(51) Int. Cl. F16G 5/16

(52) U.S. Cl. CPC F16G 5/16; F16H 7/02

(57) ABSTRACT

A driving belt that can limit damages on a hoop and elements. A boss projecting from a front surface of the element is inserted into a hole formed on a rear surface of the fellow adjacent element to form an element array, and the element array is fastened by a hoop. A radially inner clearance between a leading edge of the boss of the element and the hole of the fellow adjacent element in the radial direction is set wider than a radially outer clearance between the leading edge of the boss of the element and the hole of the fellow adjacent element in the radial direction, within a straight region of the driving belt between the pulleys.

### CROSS REFERENCE TO RELATED APPLICATIONS

The present disclosure claims the benefit of Japanese Patent Application No. 2018-202674 filed on Oct. 29, 2018 with the Japanese Patent Office, the disclosure of which is incorporated herein by reference in its entirety.

### BACKGROUND

### Field of the Disclosure

Embodiments of the present disclosure relate to the art of a driving belt used in a transmission device such as a continuously variable transmission, and more specifically, to a driving belt comprising a plurality of plate-like elements juxtaposed in the same orientation and a hoop fastening the elements.

### Discussion of the Related Art

Examples of a conventional driving belt such as a push belt are described in JP-A-H11-108122 and JP-A-2008-151266. In the conventional driving belt, several hundreds of metal elements (or blocks) are fastened by a hoop (or carrier, ring etc.) with their postures aligned. Each of the elements has a boss on one face and a hole on the other face, and the boss and hole are fitted together with those of adjacent elements to maintain an array of the elements. The driving belt thus formed is wound around a pair of pulleys each of which comprises a fixed sheave and a movable sheave. In the pulleys, the elements fastened by the hoop are clamped by the sheaves of each pulley to frictionally transmit torque of a primary pulley to a secondary pulley, and a torque transmitting capacity of the driving belt is governed by a clamping pressure of the pulley. When the primary pulley is rotated by torque applied thereto, the elements clamped by the sheaves of the primary pulley are progressed by the rotation of the primary pulley. After coming out of the primary pulley, the elements push the preceding elements toward the secondary pulley in the straight section of the belt while keeping their postures parallel to one another. Eventually, the elements enter into a groove between the sheaves of the secondary pully thereby rotating the secondary pulley. That is, the torque of the primary pulley is transmitted to the secondary pulley. In the grooves of pulleys, the each of the elements inclines with respect to the following elements to spread like a fan.

In the driving belt taught by JP-A-H11-108122, in order to prevent a relative rotation between the adjacent elements, the bosses and holes are shaped into an oval shape in the radial direction of the belt. In order to allow the element to incline easily with respect to the adjacent elements, a clearance between the bosses and the holes in the radial direction is set wider than that in the width direction.

On the other hand, according to one embodiment of JP-A-2008-151266 a hole of the element is shaped into substantially triangular shapes in which each side is curved inwardly, and a boss of the adjoining element that is shaped into a column shape is inserted into the hole of the preceding element. According to the teaching of JP-A-2008-151266, therefore, the elements joined though the boss and the hole may be aligned by the curved sides of the holes even if the elements are displaced in the width direction.

Specifically, according to the teachings of JP-A-H11-108122, the clearance between the boss and the hole of the adjoining elements is set in such a manner as to prevent the elements situated between pulleys from being contacted tightly to each other. In other words, the boss and the hole of the adjoining elements will not be brought into contact to each other within straight regions of the driving belt between the pulleys. Nonetheless, when the driving belt is vibrated, or when the element enters into a groove of the pulley, the boss and the hole of the adjoining elements are brought into contact to each other thereby maintaining a relative position between the adjoining elements to prevent misalignment.

In the groove of the pulley, however, the element coming out of the pulley is pulled radially inwardly by the pulley along a rotational direction of the pulley. In this situation, the element thus being pulled radially inwardly is pulled back radially outwardly by the hoop fastening the element array. Consequently, the element coming out of the pulley is inclined. Consequently, the hole of the element coming out of the pulley is brought into contact to the boss of the following element that is still remaining the pulley, and the element coming out of the pulley is subjected to a load to be pulled father inwardly. The load pulling the element radially inwardly acts as a shearing force on the hoop through the element coming out of the pulley. Such disadvantage may be caused not only at an exit of the primary pulley but also at an exit of the secondary pulley. However, the primary pulley is rotated by a torque of e.g., a prime mover and hence pushing forces of the elements pushed out of the primary pully to push the preceding elements are strong enough to establish a component or load counteracting the load pulling the element radially inwardly. Therefore, the element is allowed to come out of the primary pulley relatively smoothly. Whereas, the secondary pulley is rotated passively and hence the pushing forces of the elements pushed out of the primary pully to push the preceding elements are relatively weak. Therefore, the hoop is subjected to the above-mentioned shearing force repeatedly by the elements coming out of the secondary pulley.

Aspects of embodiments of the present disclosure have been conceived noting the preceding technical problems, and it is therefore an object of the present disclosure to provide a driving belt that can limit damages on a hoop and elements.

### SUMMARY

Embodiments of the present disclosure relates to a driving belt that is applied to grooves of a pair of pulleys, comprising a plurality of elements juxtaposed in a same orientation, and a hoop fastening the elements in a loop form. The element includes a hole formed on any one of a front surface and a rear surface of the element, and a boss projecting from the other one of the front surface and the rear surface of the element that is inserted into the hole of a fellow adjacent element to form an element array. In order to achieve the above-explained objective, according to the embodiment of the present disclosure, a radially inner clearance between a leading edge of the boss of the element and the hole of the fellow adjacent element in the radial direction is set wider than a radially outer clearance between the leading edge of the boss of the element and the hole of the fellow adjacent element in the radial direction, within a straight region of the driving belt between the pulleys.

In a non-limiting embodiment, the radially inner clearance between the leading edge of the boss of the element and the hole of the fellow adjacent element in the radial direction may be set wider than a clearance between the leading edge of the boss of the element and the hole of the fellow adjacent element in the width direction.

In a non-limiting embodiment, the boss may be situated unevenly in the hole of the fellow adjacent element toward radially outer side.

In a non-limiting embodiment, the boss ay be shaped into a truncated conical shape having a tapered surface in which an inclination of a radially inner section with respect to a height direction of the element is steeper than an inclination of a radially outer section with respect to the height direction of the element.

In a non-limiting embodiment, the element may further include: a base section as a main body portion of the element; a saddle surface formed in a top surface of the base section of the element to which an inner peripheral surface of the hoop is contacted; a pair of pillar sections erected on width ends of the saddle surface while maintaining a clearance therebetween wider than a width of the hoop; and a pair of hook sections protruding toward each other in the width direction from the pillar sections to be opposed to width ends of an outermost layer of the hoop. In addition, the hole and the boss may be formed at a width center of the base section.

As described, the element progresses parallel to one another in the straight region of the driving belt between the pulleys, and spread like a fan in the curved region within the groove of the pulley. When the element comes out of the groove of the pulley, the element is pulled radially inwardly by a rotation of the pulley while being inclined, and pulled back radially outwardly by the hoop strained between the pulleys. Consequently, the radially inner section of the hole of the element coming out of the groove of the pulley comes close to the boss of the following element inserted into the hole. However, according to the embodiment of the present disclosure, the radially inner clearance between the leading edge of the boss of the element and the hole of the fellow adjacent element in the radial direction is set wider than the radially outer clearance between the leading edge of the boss of the element and the hole of the fellow adjacent element in the radial direction. According to the embodiment of the present disclosure, therefore, a collision of the radially inner section of the hole of the element coming out of the groove of the pulley against the boss of the following element can be avoided. In this situation, even if the radially inner section of the hole of the element coming out of the groove of the pulley comes into contact to the boss of the following element, the radially inward displacement of the element coming out of the groove of the pulley resulting from the collision of the hole against the boss of the following element can be reduced. In addition, a shearing force applied to the hoop by the element thus displaced radially inwardly and outwardly may also be reduced. For these reasons, damages on the elements and the hoop can be limited to extend a lifetime of the driving belt.

### BRIEF DESCRIPTION OF THE DRAWINGS

Features, aspects, and advantages of exemplary embodiments of the present invention will become better understood with reference to the following description and accompanying drawings, which should not limit the invention in any way.

FIG. 1A is a top view and FIG. 1B is a side view showing a pair of pulleys and a driving belt applied to the pulleys respectively;

FIG. 2 is a partial perspective view showing a structure of a hoop;

FIG. 3 is a front view showing a configuration of the element according to the first embodiment;

FIG. 4 is a partial cross-sectional view showing a cross-section of an array of the elements according to the first embodiment fastened by the hoop;

FIG. 5 is a schematic illustration showing clearance between a boss and a hole of the element;

FIG. 6 is a schematic illustration showing changes in postures of the elements coming out of the driven pulley;

FIG. 7A is a front view of an element according to a comparative example showing loads applied to the element when coming out of the pulley, and FIG. 7B is a front view of the element according to the present disclosure showing loads applied to the element when coming out of the pulley; and

FIG. 8 is a partial cross-sectional view showing a cross-section of an array of the elements according to the second embodiment fastened by the hoop.

### DETAILED DESCRIPTION OF THE PREFERRED EMBODIMENT(S)

Embodiments of the present disclosure will now be explained with reference to the accompanying drawings. Note that the embodiments shown below are merely examples of cases where the present disclosure has been actualized, and do not limit the present disclosure.

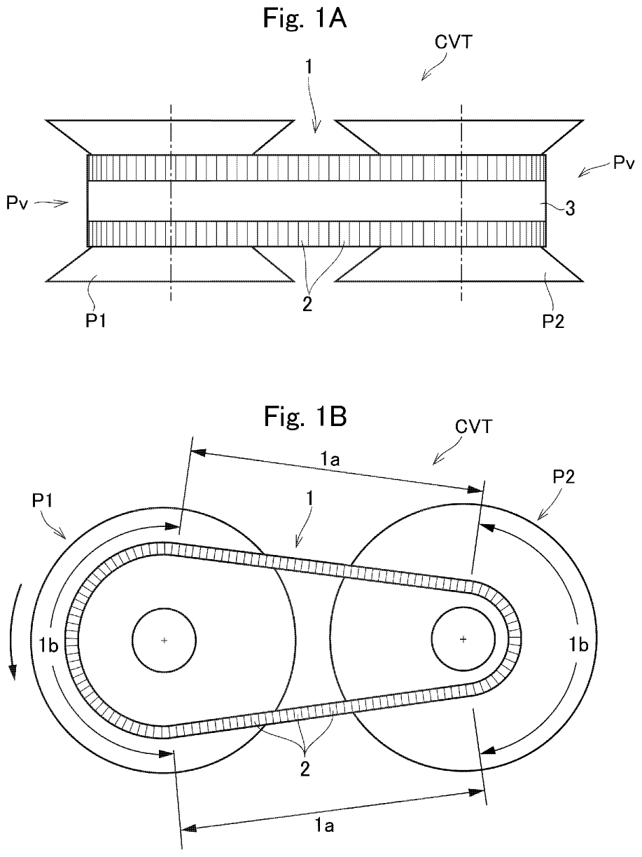

A driving belt 1 according to the embodiment of the present disclosure is employed as a V belt of a belt-driven continuously variable transmission (to be abbreviated as the “CVT” hereinafter) installed in a vehicle to transmit power between two pulleys. Specifically, as shown in FIGS. 1A and 1B, the driving belt 1 is wound on respective grooves Pv of a drive pulley P1 and a driven pulley P2 of the CVT. The driving belt 1 is a so-called a “push belt” in which a plurality of thin metal elements 2 are juxtaposed in a same orientation, and the elements 2 are fastened in a loop form by a hoop 3. In the CVT, the elements 2 sequentially enter into the grooves Pv of the drive pulley P1 and the driven pulley P2 with a rotation of the drive pulley P1. In this situation, the elements 2 pushed out of the groove Pv of the drive pulley P1 push the preceding elements so that the driven pulley P2 is rotated frictionally by the elements 2 being pushed into the groove Pv of the driven pulley P2.

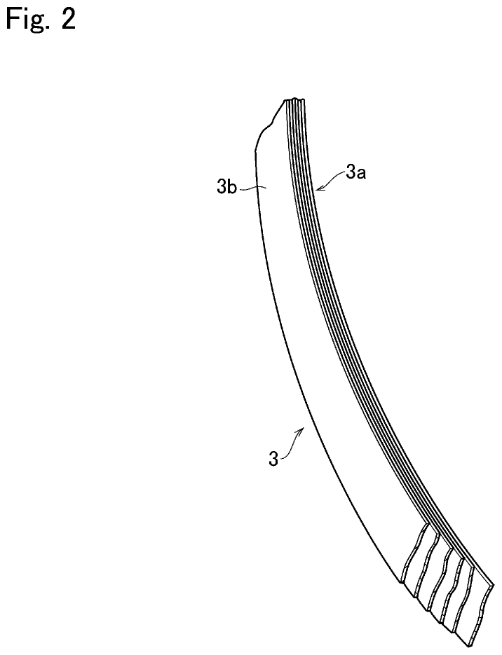

The hoop 3 is an endless metal band that is also called a carrier and a ring. As illustrated in FIG. 2, the hoop 3 is formed of a plurality of layers of a flexible metal band such as a steel band.

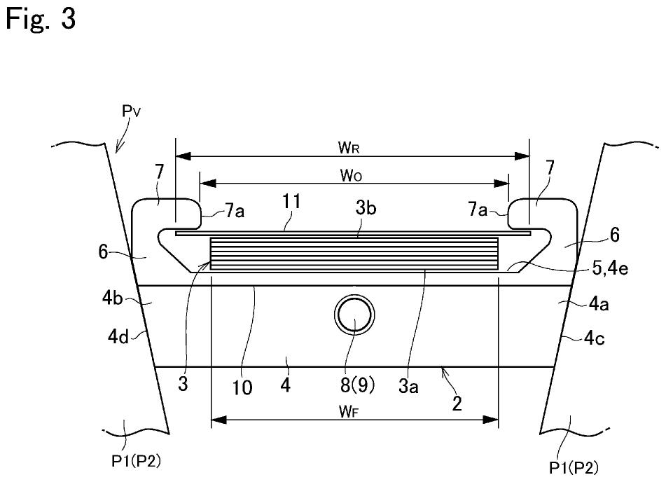

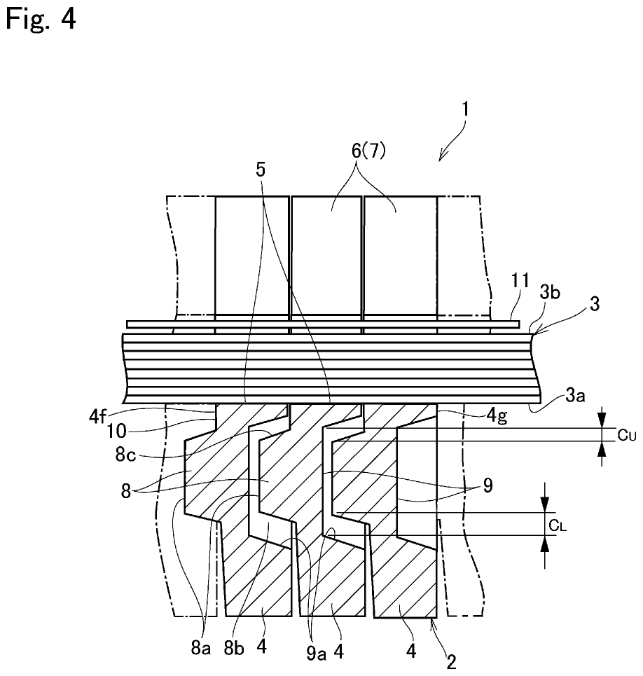

As explained above, the driving belt 1 according to the embodiment of the present disclosure includes the plurality (e.g., several hundred) of the elements 2. Specifically, as illustrated in FIGS. 3 and 4, the element 2 comprises a base section 4, a saddle surface 5, a pair of pillar sections 6, a pair of hook sections 7, a boss 8, and a hole 9.

The base section 4 is a main body portion of the element 2. In the example shown in FIG. 3, an end section on the right side of the base section 4 configures a first end section 4a, and an end section on the left side of the base section 4 configures a second end section 4b. An end surface 4c of the first end section 4a and an end surface 4d of the second end section 4b are formed respectively as an inclined surface inclined parallel to conical surfaces of the pulley groove Pv. These right and left end surfaces 4c, 4d are so-called flank surfaces of the element 2 contacted to the pulley groove Pv so as to frictionally transmit a torque between the drive pulley P1 and the driven pulley P2 through the driving belt 1.

The saddle surface 5 is formed in a top surface 4e of the base section 4 (an up-down direction of FIGS. 3 and 4) of the element 2, and is brought into contact to an inner peripheral surface 3a of the hoop 3 to assemble the driving belt 1. Specifically, the saddle surface 5 is formed in the top surface 4e between the pair of pillar sections 6 respectively formed in both end sections 4a and 4b of the base section 4.

Each of the pillar sections 6 is erected on the saddle surface 5 at the respective end sections 4a and 4b of the base section 4. In the example shown in FIG. 3, each of the pillar sections 6 extends out upwardly in a height direction of the base section 4, from the respective end sections 4a and 4b. For example, the pillar sections 6 may be formed integrally with the base section 4 by punching the element 2 out of a metal plate material.

Each of the hook sections 7 protrudes from the respective pillar sections 6 toward the width center of the element 2. In the example shown in FIG. 3, specifically, each of the hook sections 7 projects toward the width center of the element 2 from respective upper end sections of the pillar sections 6 in the height direction of the base section 4. The hook sections 7 are also formed integrally with the pillar sections 6 and the base section 4.

The boss 8 is formed at the width center of the element 2. Specifically, the boss 8 projects forward from a front surface 4f of the base sections 4 in a plate thickness direction of the element 2. As shown in FIG. 4, the boss 8 is loosely fitted into the hole 9 of a preceding element 2 to form an element array.

The hole 9 to which the boss 8 is inserted is also formed at the width center of the element 2. Specifically, the hole 9 as a depression is formed on a rear surface 4g of the base section 4 at the width center of the element 2, and the boss of the following element 2 is inserted loosely into the hole 9.

By thus joining the boss 8 into the hole 9, fellow adjacent elements 2 are positioned, and relative movement of those fellow adjacent elements 2 is restricted to maintain the loop form of the element array.

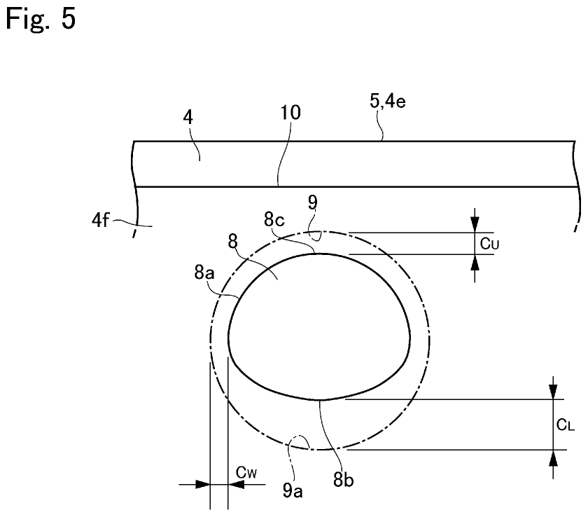

Hereafter, shapes of the boss 8 and the hole 9, and a clearance between the elements 2 connected through the boss 8 and the hole 9 will be explained in more detail. FIG. 5 is a schematic illustration showing the boss 8 and the hole 9 of the adjacent elements 2 joining together in straight regions 1a of the driving belt 1. The straight regions 1a are portions of the driving belt 1 running between the drive pulley P1 and the driven pulley P2. As illustrated in FIG. 5, the hole 9 is shaped into a substantially circular shape. On the other hand, the boss 8 is shaped into a rounded triangle shape in which a radially inner portion (i.e., a lower portion in the height direction) is substantially flattened. That is, a curvature radius of a tapered surface of the boss 8 at the radially inner section 8b is longer than a curvature radius of the tapered surface of the boss 8 at the remaining portion (i.e., at a radially outer section 8c of the boss 8). In other words, the boss 8 is situated unevenly in the hole 9 of the fellow adjacent element 2 toward radially outer side. In the driving belt 1, therefore, the boss 8 of the element 2 inserted into the hole 9 of the preceding element 2 exists only within the radially outer space of the hole 9.

Specifically, a radially inner clearance C_{L} between a leading edge 8a of the boss 8 and a radially inner portion of an inner surface 9a of the hole 9 in the radial direction is wider than a radially outer clearance C_{U} between the leading edge 8a of the boss 8 and a radially outer portion of the inner surface 9a of the hole 9. Therefore, it is possible to reduce a contact load resulting from a contact between the hole 9 of the preceding element 2 being pulled out of the groove Pv of the driven pulley P2 and the boss 8 of the following element 2 still remaining in the groove Pv of the driven pulley P2. The radially inner clearance C_{L} is also wider than a width clearance C_{W} between the tapered surface of the boss 8 and the inner surface 9a of the hole 9 in the width direction. The widths of these clearances C_{U}, C_{L}, and C_{W} may be set based on an experimental result.

In the grooves Pv of pulleys P1 and P2, the elements 2 in a curved region 1b of the driving belt 1 are inclined respectively to spread like a fan with respect to the rocking edge 10. An amount of such change in the posture (or inclination) of the elements 2, that is, a pitching angle of the element 2 in the curved region 1b of the driving belt 1a in a running direction may be changed by adjusting the radially outer clearance C_{U}. For example, the pitching angle of each of the elements 2 in the curved region 1b of the driving belt 1a may be increased by widening the radially outer clearance C_{U}. Consequently, an angle between the adjacent elements 2 inclined respectively in the curved region 1b of the driving belt 1a is widened. Likewise, a relative displacement of the adjacent elements 2 in the width direction may be changed by adjusting the width clearance C. For example, the relative displacement of the adjacent elements 2 in the width direction may be reduced by narrowing the width clearance C. Consequently, a misalignment between the adjacent elements 2 in the width direction may be prevented.

As explained above, the array of the elements 2 is fastened by the hoop 3 in a loop form in the same orientation, and is applied to the drive pulley P1 and the driven pulley P2. In the grooves Pv of the pulleys P1 and P2, the elements 2 spread like a fan with respect to the rotational centers of the pulleys P1 and P2 while being contacted closely to one another at the base section 4. Therefore, a thickness of the lower portion of the base section 4 of the elements 2 is reduced gradually as compared to that of an upper portion. As shown in FIG. 4, specifically, the rocking edge 10 is formed in the front surface 4f of the base section 4 at a lower side than the saddle surface 5. The thickness of the base section 4 is thinned from the rocking edge 10 toward the lower side than the rocking edge 10. In the grooves Pv of the pulleys P1 and P2 within the curved region 1b of the driving belt 1, therefore, the rocking edge 10 contacts the rear surface 4g of the base section 4 of the preceding element 2.

As shown in FIG. 3, in the element 2, an opening width W_{O} between tip sections 7a of the hook sections 7 being opposed to each other is wider than a width W_{F} of the hoop 3. Therefore, the hoop 3 is allowed to pass easily through the opening between the tip sections 7a of the hook sections 7 to fasten the array of the elements 2 by the hoop 3.

The driving belt 1 further comprises a retainer ring 11 as an endless metal band that prevents a disengagement of the element 2 from the hoop 3. As shown in FIG. 3, the retainer ring 11 is disposed on an outer peripheral surface 3b of the hoop 3, and a width W_{R} of the retainer ring 11 is wider than the width W_{F} of the hoop 3 and the opening width W_{O} of the element 2. Therefore, both width ends of the retainer ring 11 is brought into contact to the hook sections 7 respectively thereby preventing disengagement of the hoop 3 from the array of the elements 2. For example, the retainer ring 11 may be inserted into the element 2 by buckling the retainer ring 11 in the width direction after fastening the array of the elements 2 by the hoop 3. Optionally, in order to easily buckle the retainer ring 11, an oval hole(s) which is longer in the circumferential direction (not shown) may be formed in the retainer ring 11.

Next, an action of the driving belt 1 will be explained hereinafter. As described, the elements 2 are spread like a fan within each of the curved regions 1b around the rotational centers of the drive pulley P1 and the driven pulley P2. In other words, each of the elements 2 in the curved region 1b of the driving belt 1 inclines radially with respect to the rotational centers of the drive pulley P1 and the driven pulley P2. In the drive pulley P1 rotated by the torque applied thereto, the elements 2 clamped within the pulley groove Pv by the sheaves of the drive pulley P1 are progressed while being inclined, and pushed out of an exit of the curved region 1b sequentially to enter into one of the straight regions 1a. Specifically, one of the elements 2 at the border between the curved region 1b and the straight regions 1a of the driving belt 1 at the exit of the groove Pv of the drive pulley P1 is pushed out of the groove Pv by the following elements 2 to enter into the straight regions 1a. In this situation, the following element 2 is pulled radially inwardly by the conical surfaces of the drive pulley P1 along the rotational direction of the drive pulley Pl. However, when the following elements 2 is pushed out of the groove Pv of the driven pulley P1, the following element 2 is pulled back radially outwardly by the retainer ring 11 stretched taut within the straight region 1a while being contacted to the hook sections 7 of the following element 2b.

When the element 2 is thus pushed out of the groove Pv of the drive pulley P1 by the following element 2, the element 2 is inclined with respect to the following element 2 about to come out of the groove Pv. Consequently, the radially inner portion of the inner surface 9a of the hole 9 of the element 2 comes close to the leading edge 8a of the boss 8 of the following element 2. However, according to the first embodiment of the disclosure, the radially inner clearance C_{L} is wider than the radially outer clearance C_{U} and the width clearance C_{W}. According to the first embodiment of the disclosure, therefore, the radially inner portion of the inner surface 9a of the hole 9 of the element 2 will not come into contact to the leading edge 8a of the boss 8 of the following element 2.

The elements 2 thus pushed out of the groove Pv of the drive pulley P1 sequentially push the preceding elements 2 toward the driven pulley P2, and the elements 2 pushed out of the groove Pv of the drive pulley P1 progress in the straight regions 1a while keeping the posture thereof parallel to one another. Eventually, the elements 2 sequentially enter into the groove Pv of the driven pulley P2 at the curved region 1b of the driving belt 1, and further progressed by the following elements 2 to rotate the driven pulley P2 while being spread like a fan. That is, the torque of the drive pulley P1 is transmitted to the driven pulley P2 through the elements 2 frictionally contacted with the conical surfaces of the driven pulley P2.

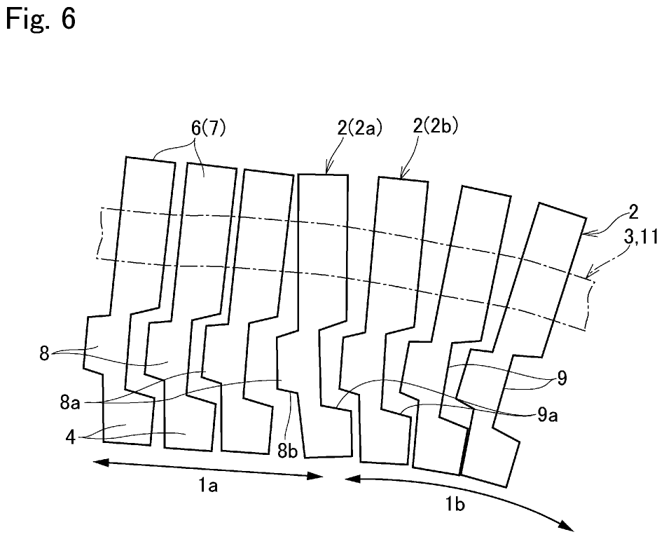

Likewise, the element 2 is also pushed out of the groove Pv of the driven pulley P2 by the following element 2 to enter into the other one of the straight regions 1a. In this situation, the following element 2 is also pulled radially inwardly along the rotational direction of the driven pulley P2, but also pulled back radially outwardly by the retainer ring 11 and the hoop 3 to come out of the groove Pv of the driven pulley P2. When the element 2 is thus pushed out of the groove Pv of the driven pulley P2 by the following element 2, the element 2 is inclined with respect to the following element 2 about to come out of the groove Pv. FIG. 6 schematically illustrates such change in the postures of the elements 2a and 2b coming out of the groove Pv of the driven pulley P2, at the border between the curved region 1b and the straight region 1a of the driving belt 1. In order to expedite understanding, in FIG. 6, a clearance between the elements 2a and 2b is exaggerated. When the preceding element 2a is inclined, the radially inner portion of the inner surface 9a of the hole 9 of the element 2a comes close to the leading edge 8a of the boss 8 of the following element 2b about to come out of the groove Pv. However, according to the first embodiment of the disclosure, the radially inner clearance C_{L} between e.g., the elements 2a and 2b is radially wider than the radially outer clearance C_{U} and the width clearance C_{W}. According to the first embodiment of the disclosure, therefore, the radially inner portion of the inner surface 9a of the hole 9 of the element 2a will not come into contact to the leading edge 8a of the boss 8 of the following element 2b.

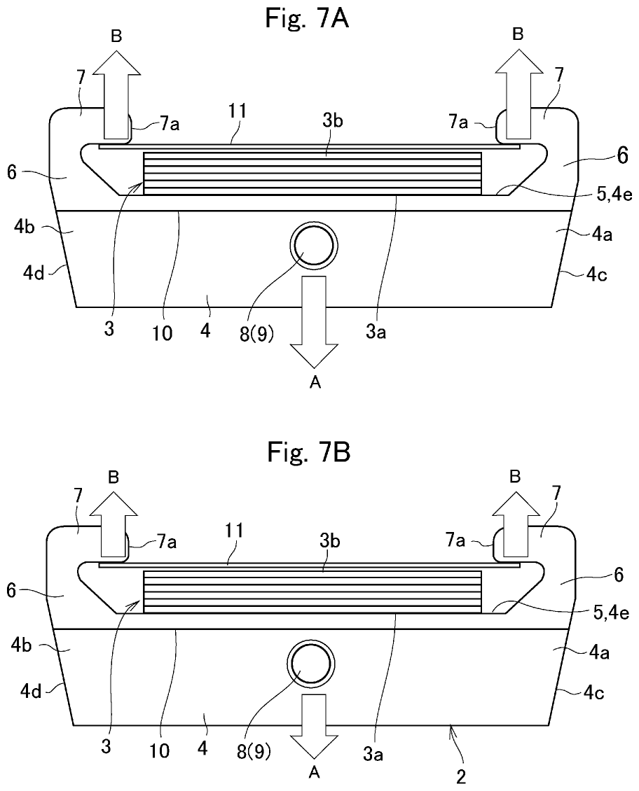

Here will be explained a load applied to the element 2 when pushed out of the groove Pv by the following element 2, with reference to FIGS. 7A and 7B. Specifically, FIG. 7A shows a comparative example of the element in which the radially inner clearance C_{L} is radially narrower than the radially outer clearance C_{U} and the width clearance C. Whereas, FIG. 7B shows the element 2 according to the first embodiment of the present disclosure in which the radially inner clearance C_{L} is radially wider than the radially outer clearance C_{U} and the width clearance C. As before-described, the element 2b about to come out of the grooves Pv of the pulley P1 or P2 is pulled radially inwardly by the conical surfaces of the pulley P1 or P2 along the rotational direction of the pulley. In this situation, in the element shown in FIG. 7A in which the radially inner clearance C_{L} is radially narrower than the other clearances C_{U} and C_{W}, the radially inner portion of the inner surface 9a of the hole 9 of the preceding element comes into contact to the leading edge 8a of the boss 8 of the following element. Consequently, a contact portion between the hole 9 of the preceding element and the boss 8 of the following element is subjected to a load A in a direction to pull the preceding element radially inwardly, and the width ends of the retainer ring 11 come into contact to the hook sections 7 respectively to establish a reaction force B against the load A. In this situation, the hoop 3 is subjected to a shearing force applied thereto by the element 2 thus pulled radially inwardly by the load A. However, the drive pulley P1 is rotated by a torque of e.g., a prime mover and hence pushing forces of the elements 2 pushed out of the drive pulley P1 to push the preceding elements 2 are strong enough to establish a component or load counteracting the load A pulling the element 2 radially inwardly. Therefore, the element 2 is allowed to come out of the drive pulley P1 relatively smoothly. Whereas, the driven pulley P2 is rotated passively and hence the pushing forces of the elements 2 pushed out of the driven pulley P2 to push the preceding elements 2 are relatively weak. Therefore, the component or load counteracting the load A will not be established at the exit of the groove Pv of the driven pulley P2.

As described, in the element 2 according to the first embodiment of the disclosure, the radially inner clearance C_{L} is wider than the other clearances C_{U} and C_{W} in the radial direction. Therefore, then the element 2 is pushed out of the groove of the driven pulley P2 by the following element 2, the radially inner portion of the inner surface 9a of the hole 9 of the preceding element 2 will not come into contact to the leading edge 8a of the boss 8 of the following element 2. In this situation, even if the hole 9 of the preceding element 2 comes into contact to the boss 8 of the following element 2, the load A pulling the preceding element 2 radially inwardly may be reduced as indicated by the shorter arrow in FIG. 2B. For this reason, a damage on the hoop 3 by the shearing force, and a friction between the elements 2 joining to each other may be limited. Consequently, a lifetime or a period of endurance of the driving belt may be extended.

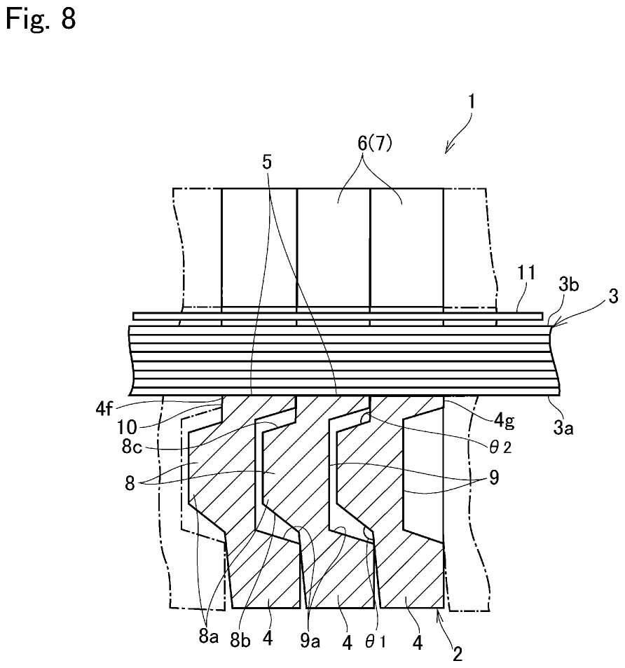

Turning to FIG. 8, there is shown a partial cross-section of an array of the elements 2 according to the second embodiment. As illustrated in FIG. 4, the boss 8 of the element 2 according to the first embodiment is shaped into a truncated conical shape. According to the second embodiment, as illustrated in FIG. 8, an inclination θ1 of the tapered surface of the boss 8 at the radially inner section 8b with respect to the height direction of the element 2 is steeper than an inclination θ2 of the tapered surface at a radially outer section 8c of the boss 8 with respect to the height direction of the element 2. The inclinations θ1 and θ2 of the tapered surface of the boss 8 may be set based on an experimental result.

Therefore, when the hole 9 of the preceding element 2 comes into contact to the boss 8 of the following element 2, a component force in a direction to reduce the contact load A will be established at the contact portion between the hole 9 of the preceding element 2 and the radially inner section 8b of the boss 8 of the following element 2. For this reason, the load A pulling the element 2 coming out of the groove Pv of e.g., the driven pulley P2 radially inwardly can be further reduced to limit damages on the element 2 and the hoop 3.

Although the above exemplary embodiments of the present disclosure have been described, it will be understood by those skilled in the art that the present disclosure should not be limited to the described exemplary embodiments, and various changes and modifications can be made within the scope of the present disclosure. For example, the hole 9 of the element 2 may be shaped into an oval shape extended toward the lower end of the element 2. In addition, the boss 8 may be shaped into a semicircle shape in which the lower half is omitted. Further, the boss 8 and the hole 9 may also be formed in the pillar sections 6 and the hook sections 7.

What is claimed is:

1. A driving belt that is applied to grooves of a pair of pulleys, comprising:
a plurality of elements juxtaposed in a same orientation; and
a hoop fastening the elements in a loop form,
wherein the element includes
a hole formed on any one of a front surface and a rear surface of the element, and
a boss projecting from the other one of the front surface and the rear surface of the element that is inserted into the hole of a fellow adjacent element to form an element array, and
a radially inner clearance between a leading edge of the boss of the element and the hole of the fellow adjacent element in the radial direction is set wider than a radially outer clearance between the leading edge of the boss of the element and the hole of the fellow adjacent element in the radial direction, within a straight region of the driving belt between the pulleys.

2. The driving belt as claimed in claim 1, wherein the radially inner clearance between the leading edge of the boss of the element and the hole of the fellow adjacent element in the radial direction is set wider than a clearance between the leading edge of the boss of the element and the hole of the fellow adjacent element in the width direction.

3. The driving belt as claimed in claim 1, wherein the boss is situated unevenly in the hole of the fellow adjacent element toward radially outer side.

4. The driving belt as claimed in claim 1, wherein the boss is shaped into a truncated conical shape having a tapered surface in which an inclination of a radially inner section with respect to a height direction of the element is steeper than an inclination of a radially outer section with respect to the height direction of the element.

5. The driving belt as claimed in claim 2, wherein the boss is shaped into a truncated conical shape having a tapered surface in which an inclination of a radially inner section with respect to a height direction of the element is steeper than an inclination of a radially outer section with respect to the height direction of the element.

6. The driving belt as claimed in claim 3, wherein the boss is shaped into a truncated conical shape having a tapered surface in which an inclination of a radially inner section with respect to a height direction of the element is steeper than an inclination of a radially outer section with respect to the height direction of the element.

7. The driving belt as claimed in claim 1,
wherein the element further includes
a base section as a main body portion of the element,
a saddle surface formed in a top surface of the base section of the element to which an inner peripheral surface of the hoop is contacted,
a pair of pillar sections erected on width ends of the saddle surface while maintaining a clearance therebetween wider than a width of the hoop, and
a pair of hook sections protruding toward each other in the width direction from the pillar sections to be opposed to width ends of an outermost layer of the hoop, and
wherein the hole and the boss are formed at a width center of the base section.

8. The driving belt as claimed in claim 2,
wherein the element further includes
a base section as a main body portion of the element,
a saddle surface formed in a top surface of the base section of the element to which an inner peripheral surface of the hoop is contacted,
a pair of pillar sections erected on width ends of the saddle surface while maintaining a clearance therebetween wider than a width of the hoop, and
a pair of hook sections protruding toward each other in the width direction from the pillar sections to be opposed to width ends of an outermost layer of the hoop, and
wherein the hole and the boss are formed at a width center of the base section.

9. The driving belt as claimed in claim 3,
wherein the element further includes
a base section as a main body portion of the element,
a saddle surface formed in a top surface of the base section of the element to which an inner peripheral surface of the hoop is contacted,
a pair of pillar sections erected on width ends of the saddle surface while maintaining a clearance therebetween wider than a width of the hoop, and
a pair of hook sections protruding toward each other in the width direction from the pillar sections to be opposed to width ends of an outermost layer of the hoop, and
wherein the hole and the boss are formed at a width center of the base section.

10. The driving belt as claimed in claim 4,
wherein the element further includes
a base section as a main body portion of the element,
a saddle surface formed in a top surface of the base section of the element to which an inner peripheral surface of the hoop is contacted,
a pair of pillar sections erected on width ends of the saddle surface while maintaining a clearance therebetween wider than a width of the hoop, and
a pair of hook sections protruding toward each other in the width direction from the pillar sections to be opposed to width ends of an outermost layer of the hoop, and
wherein the hole and the boss are formed at a width center of the base section.

11. The driving belt as claimed in claim 5,
wherein the element further includes
a base section as a main body portion of the element,
a saddle surface formed in a top surface of the base section of the element to which an inner peripheral surface of the hoop is contacted,
a pair of pillar sections erected on width ends of the saddle surface while maintaining a clearance therebetween wider than a width of the hoop, and
a pair of hook sections protruding toward each other in the width direction from the pillar sections to be opposed to width ends of an outermost layer of the hoop, and
wherein the hole and the boss are formed at a width center of the base section.

12. The driving belt as claimed in claim 6,
wherein the element further includes
a base section as a main body portion of the element,
a saddle surface formed in a top surface of the base section of the element to which an inner peripheral surface of the hoop is contacted,
a pair of pillar sections erected on width ends of the saddle surface while maintaining a clearance therebetween wider than a width of the hoop, and
a pair of hook sections protruding toward each other in the width direction from the pillar sections to be opposed to width ends of an outermost layer of the hoop, and
wherein the hole and the boss are formed at a width center of the base section.
